(19) United States
(12) Patent Application Publication
(10) Pub. No.: US 2008/0247203 A1
(43) Pub. Date: Oct. 9, 2008

(54) Energy Efficient Power Converter

(76) Inventors: Tim Cassidy, Plymouth, MN (US); Cezar Eugene Vieira, Stoughton, MA (US); Thomas M. Ingman, Somis, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/062,881

(22) Filed: Apr. 4, 2008

Related U.S. Application Data
(60) Provisional application No. 60/910,766, filed on Apr. 9, 2007.

(51) Int. Cl. H02M 7/02

(52) U.S. Cl. 363/84; 363/125

(57) ABSTRACT

There is disclosed a power supply and method. The power supply may include a power converter for converting AC primary power into DC power, the power converter having a normal operating mode and a low power quiescent operating mode. A DC power plug may be adapted to deliver DC power from the power converter to a load. The normal operating mode and the low power quiescent operating mode of the power converter may be selected by a switch integrated into the DC power plug.

### RELATED APPLICATION INFORMATION

This patent claims benefit of the filing date of provisional patent application Ser. No. 60/910,766, filed Apr. 9, 2007, entitled “Energy efficient Power Converter”.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to power converters.

2. Description of the Related Art

Power converters are commonly used to provide power to a variety of fixed and mobile electronic devices including laptop computers, monitors, printers, cell phones, and other equipment. Power converters may provide power to charge batteries within the equipment and/or power to operate the equipment.

FIG. 1 is a block diagram of a conventional power converter 100 that accepts AC line power through a plug P1 and provides DC power to a load device through a DC power plug P2. AC power plug P1 may be connected to the power converter 100 by a cable, or may be integrated into the housing of the power converter 100. The power converter 100 may be connected to the DC power plug P2 via a two-wire cord 130. The DC power plug P2 may be physically plugged into a load device. Alternatively, the DC power plug P2 may be within or coupled to a dock. When within or coupled to a dock, the power converter may deliver power to the load device when the load device is plugged into or set upon the dock.

The power converter 100 may include a primary side 110 coupled to a secondary side 120 by a power transformer T1. The primary side 110 may contain a rectifier to rectify the AC input voltage, high frequency switching circuitry to drive the primary side of transformer T1, and control circuitry that are not shown in FIG. 1. A variety of known switching circuits may be used in the primary side 110 including bridge, half-bridge, bootstrap, and other switching circuits.

The secondary side 120 may include circuitry (not shown) to rectify and filter the high frequency AC voltage from the secondary side of transformer T1 to provide a DC output voltage to the load. The secondary side 120 may include diode rectifiers or synchronous rectifiers. The secondary side 120 may include circuitry to sense the DC output voltage and/or the DC output current provided to the load. The secondary side may conventionally provide feedback signals to control circuits in the primary side to regulate either the DC output voltage and/or the DC output current.

The primary side 110 and the secondary side 120 may include one or more sensing circuits to sense one or more conditions such as output over-current, output over-voltage and/or input under-voltage. The primary side 110 may include a shut down circuit to shut down the operation of the power converter in the event that one of these or other conditions are sensed. Sensing circuits and shut down circuits are well known in the art and commonly included in power converters.

Power converters are commonly continuously connected to the AC power supply. In this case, the total energy consumed by the power converter when the load equipment is not connected may greatly exceed the energy actually delivered to the load equipment. New regulations in the United States, Europe, and elsewhere place stringent limits on the amount of power that may be consumed by an unloaded power converter.

### DESCRIPTION OF THE DRAWINGS

FIG. 1 is a block diagram of a conventional power converter.

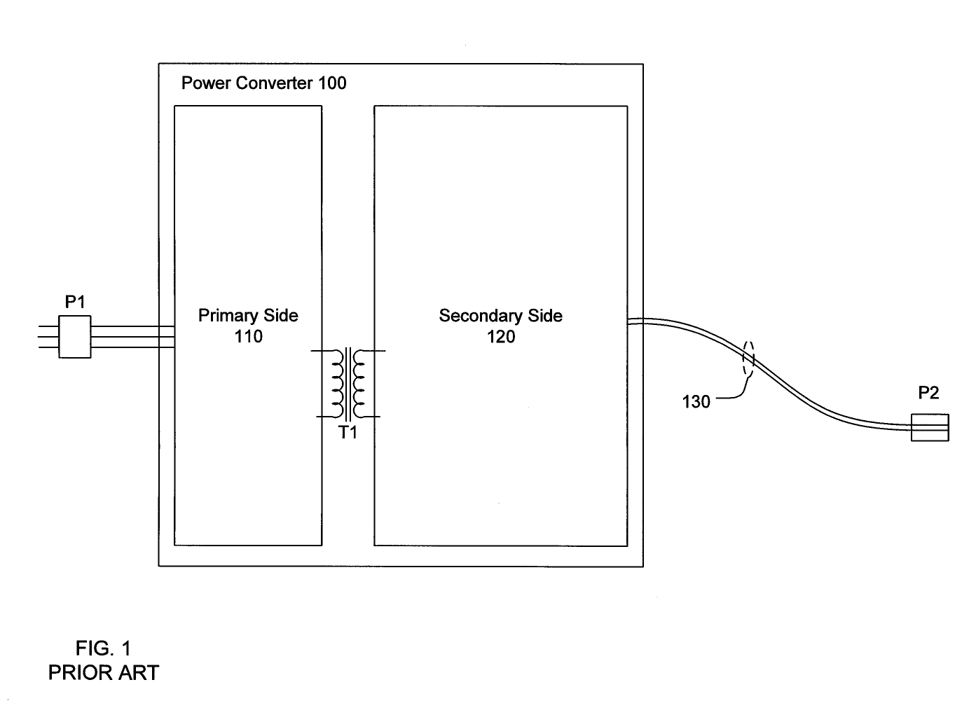

FIG. 2 is a block diagram of an energy-efficient power converter.

FIG. 3 is a partial schematic diagram of an exemplary energy-efficient power converter.

FIG. 4 is a partial schematic diagram of another exemplary energy-efficient power converter.

FIG. 5 is a block diagram of another exemplary energy-efficient power converter.

FIG. 6 is a schematic cross-sectional view of an exemplary integrated power plug and switch.

FIG. 7 is a flow cart of a process for operating a power converter.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

### Description of Apparatus

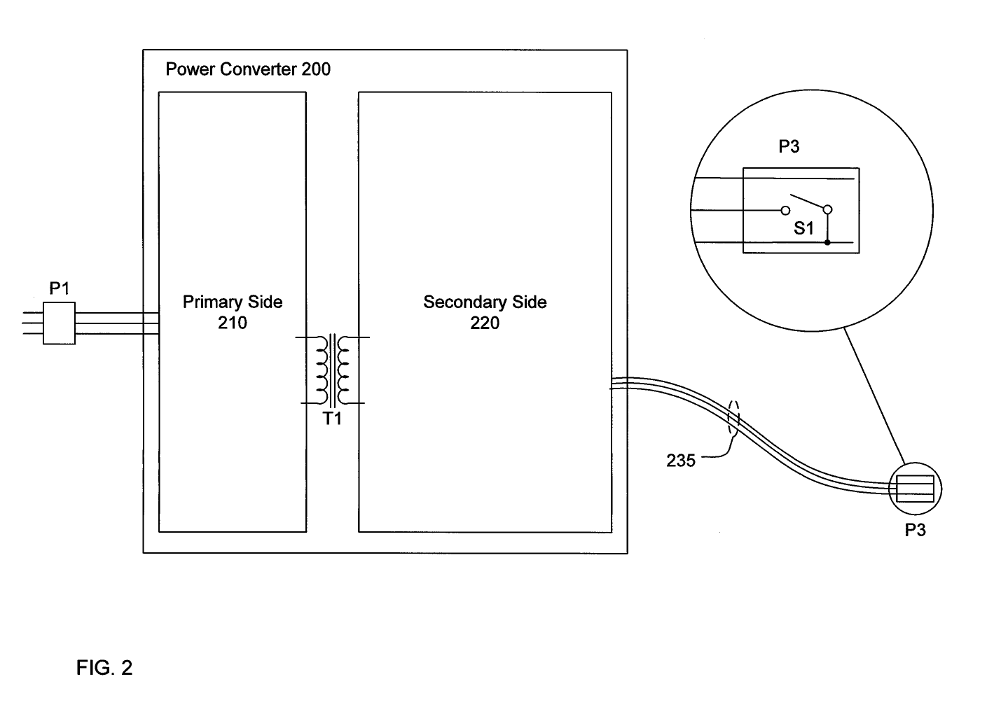

Referring now to FIG. 2, an improved power converter 200 may receive AC power through a first plug P1 and may deliver DC power to a load device through DC power plug P3. AC power plug P1 may be connected to the power converter 200 by a cable, or may be integrated into the housing of the power converter 200. The power converter 200 may be connected to the DC power plug P3 via a three-wire cord 135. The DC power plug P3 may be physically plugged into a load device. Alternatively, the DC power plug P3 may be within or coupled to a dock. When within or coupled to a dock, the power converter may deliver power to the load device when the load device is plugged into or set upon the dock.

The cable 235 may have three or more wires. Two wires in the cable 235 may deliver power to a load, and a third wire may connect to a switch S1 integrated into the DC power plug P3. The switch S1 may be normally open or normally closed when the DC power plug P3 is not engaged with the load, which may be a portable electronic device. The switch S1 may be opened (if normally closed) or closed (if normally open) when the DC power plug P3 is engaged with the load. The power converter 200 is designed to have two modes of operation—a normal operating mode and a low power quiescent operating mode. In the normal operating mode, DC power may be delivered to the load as previously described. In the low power quiescent operating mode, essentially no power may be delivered to the load and the power consumption of the power converter may be minimized. The normal operating mode or the low power quiescent operating mode may be selected by the state of switch S1.

The switch S1 may be a device that has electrically open and electrically closed states that may be used to indicate if the DC power plug P3 is connected or is not connected to a load device. The switch S1 may or may not include one or more components that move mechanically when the DC power plug P3 is connected or disconnected from the load device. The switch S1 may be two terminals that may be electrically connected by a pin, jumper wire, or other electrical component which may be a portion of or included with the load device. When the DC power plug P3 is connected to the load device, the pin, jumper wire, or other electrical component may complete an electrical circuit between two terminals of the DC power plug P3.

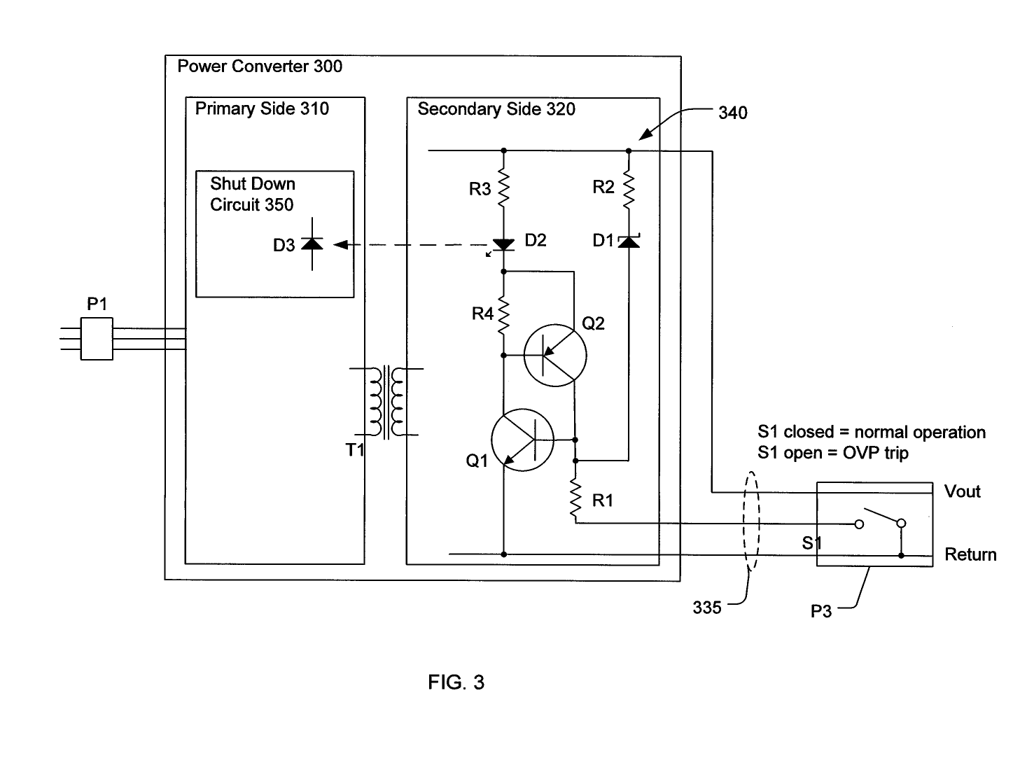

FIG. 3 is a partial schematic diagram of a power converter 300 which includes a primary side 310 and secondary side 320. The primary side 310 and the secondary side 320 are electrically isolated and coupled by a power transformer T1. The secondary side 320 may deliver DC power to a load through a DC power plug P3 which includes an integrated switch S1. In this example, the switch S1 is open when the DC power plug P3 is not connected to the load equipment and closed when the DC power plug P3 is connected to the load.

Components D1-2, R1-4 and Q1-2 comprise a sensor circuit 340 to sense the position of the switch S1. In this example, the sensor circuit 340 also functions as an over-voltage detection circuit. In normal operation, with the switch S1 closed, the transistors Q1 and Q2 are nonconductive. The transistors Q1 and Q2 are connected as a regenerative pair.

If the output voltage, Vout, exceeds the breakdown voltage of the zener diode D1, transistors Q1 and Q2 will rapidly switch on, causing current to flow through the light emitting diode D2. The light emitting diode D2 is optically coupled to a photodiode D3 which forms part of a shut down circuit 350 in the primary side 310 of the power converter 300. Light received from the light emitting diode D2 generates photocurrent in the photodiode D3. The photocurrent is detected by the shut down circuit 350, which causes the primary side 310 to enter a low power quiescent mode.

When the DC power plug P3 is not connected to the load, the switch S1 is open. Leakage current through the zener diode D1 (which may be augmented by a parallel high-value resistor if needed) will cause the transistors Q1 and Q2 to conduct, placing the primary side 210 into the low power quiescent mode.

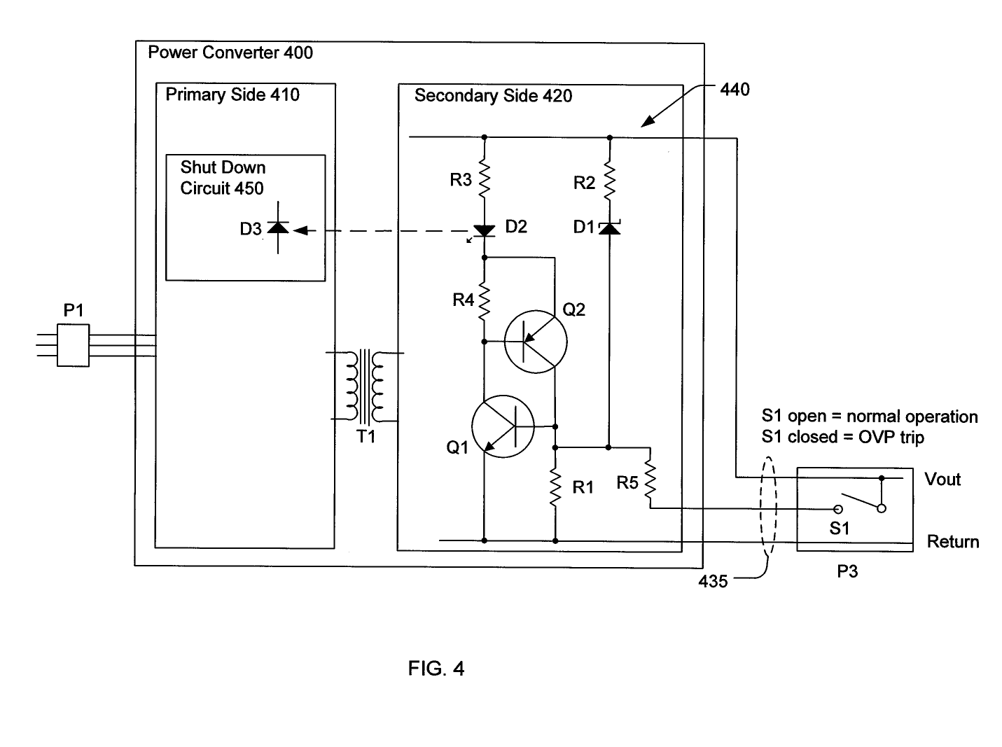

FIG. 4 is a partial schematic diagram of a power converter 400 which shows a variation of the circuit of FIG. 3. In FIG. 4, the switch S1 is closed when the DC power plug P3 is not connected to the load. With the switch S1 closed, current though a resistor R5 causes transistors Q1 and Q2 to turn on, placing the primary side 410 of the power converter 300 into a stand-by mode. With the DC power plug P3 is connected to the load, the switch S1 is open and the circuit functions normally as previously described.

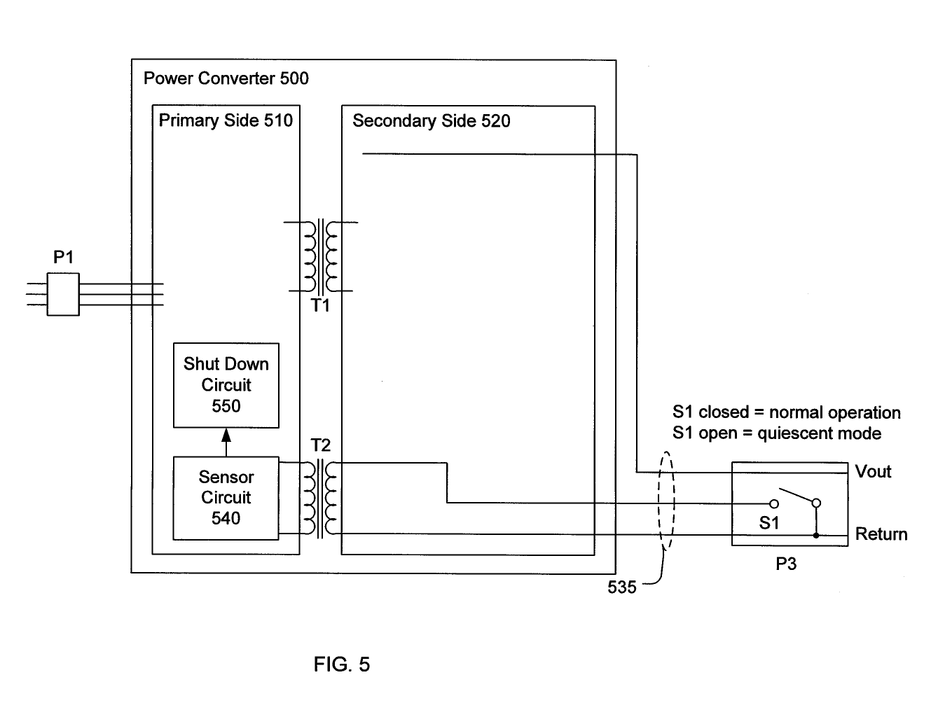

FIG. 5 is a partial schematic diagram of a power converter 500 which includes a sensor circuit 540 coupled to the shut down circuit 550 on the primary side 510. The sensor circuit 540 is connected to the switch S1 via a second transformer T2. The sensor circuit may detect the state of the switch S1 through the transformer T2 independently of the main primary side circuitry that drives transformer T1. The sensor circuit may place the main primary side circuitry into a normal mode of operation or an extremely low power quiescent state depending on the state of switch S1.

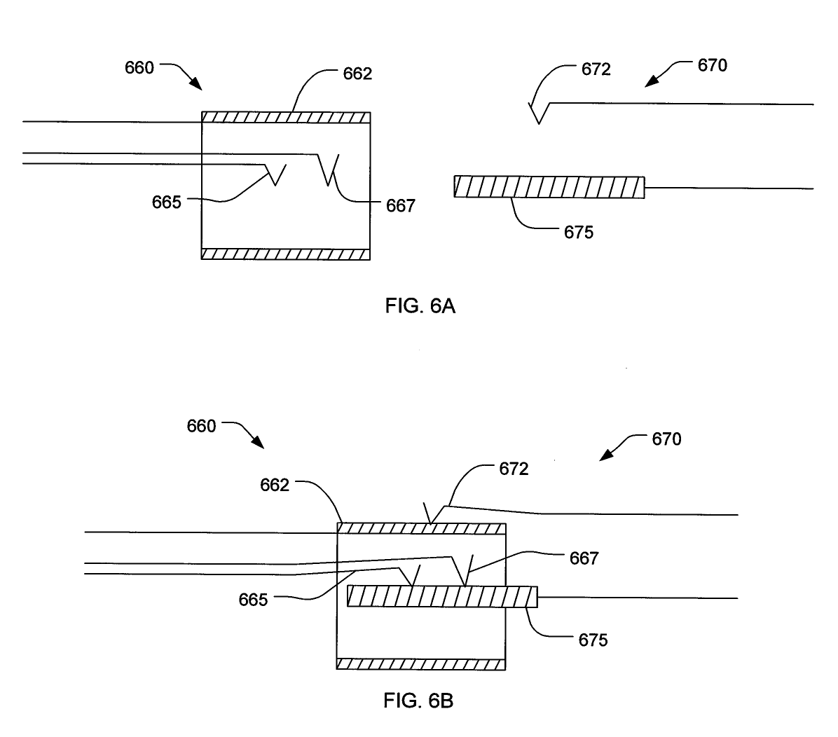

FIG. 6A and FIG. 6B are schematic cross-sectional views of an exemplary integrated DC power plug and switch 660 which may be used as the plug P3 in a power converter as described in FIGS. 2, 3, 4, and 5. FIG. 6A and FIG. 6B are intended to represent a common type of DC power plug, but are not drawn in proportion or to scale. FIG. 6A and FIG. 6B show the conductive portions of the DC power plug 660 and a mating receptacle 670, but do not show the insulating material that supports and separates the conductive portions.

Referring to FIG. 6A, the unmated DC power plug 660 may be comprised of a conductive barrel 662 (shown in cross section) and two spring contacts 665 and 667 that are electrically isolated from each other and the barrel 662. The mating receptacle 670 may be comprised of conductive pin 675 and spring contact 672.

Referring to FIG. 6B, when mated, the barrel 662 is electrically connected to spring contact 672. The pin 675 is electrically connected to both spring contacts 665 and 667. Thus spring contact 665 and 667 comprise a normally-open switch that is “closed” by the insertion of pin 675. The path through barrel 662 and spring contact 672 and the path through pin 675 and either spring contact 665 or 667 may be used to deliver power to the load equipment.

The integrated DC power plug and switch 660 and the mating receptacle 670 are exemplary and many other plug/switch and receptacle devices may be used. The receptacle 670 may be a conventional receptacle that is part of an existing electronic device, and the integrated DC power plug and switch may be adapted to mate with an existing receptacle.

Description of Processes

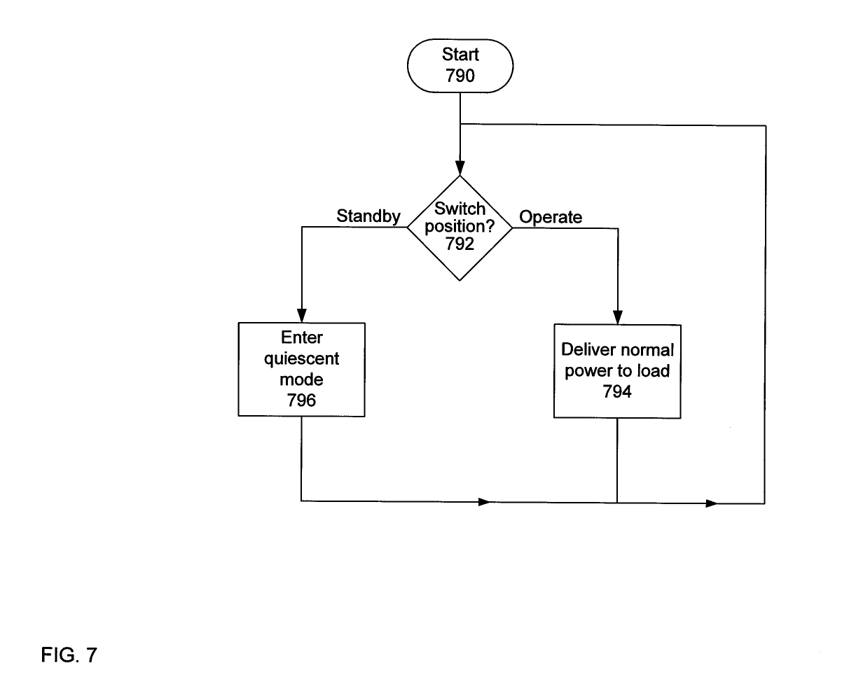

Referring now to FIG. 7, a process 700 for operating a power converter, which may be a power converter such as power converters 200, 300, 400, and 500, may start at 790 when the power converter is attached to an AC primary power supply. At 792, the position of a switch may be sensed. The switch may be integrated into a power plug that delivers DC power to a load, and the switch position may indicate if the power plug is connected to the load.

If the switch is in an “operate” position indicating that the power plug is connected to the load, the power converter may deliver DC power to the load normally at 794. If the switch is in a “standby” position indicating that the power plug is not connected to the load, the power converter may enter a low power quiescent operating mode at 796. The process may repeat continuously from 792 so long as the power converter is connected to the AC primary power supply. While the process has been conveniently shown and described in terms of sequential actions, the sensing of the switch position at 792 and either one of the quiescent operating mode at 796 or the normal operating mode at 794 may occur simultaneously and continuously.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

1. A power supply comprising:
a power converter for converting AC primary power into DC power, the power converter having a normal operating mode and a low power quiescent operating mode
a DC power plug for delivering DC power from the power converter to a load
wherein the normal operating mode and the low power quiescent operating mode are selected by a switch integrated into the DC power plug.

2. The power supply of claim 1, wherein the switch has a first state indicating that the DC power plug is not engaged with a load and a second state indicating that the DC power plug is engaged with a load.

3. The power supply of claim 2, wherein the power converter comprises:
a primary side to receive AC primary power
a secondary side to deliver DC power to the load
a power transformer coupling the primary side and the secondary side.

4. The power supply of claim 3, wherein
the primary side comprises a shut down circuit to place the power supply in the low power quiescent operating mode
one of the primary side and the secondary side comprises a sensing circuit to sense the state of the switch
wherein the sensing circuit causes the shut down circuit to place the power converter into the low power quiescent operating mode when the switch is in the first state.

5. The power supply of claim 4, wherein
the sensing circuit is on the secondary side and optically coupled to the shut down circuit.

6. The power supply of claim 5, wherein the sensing circuit also senses an output over-voltage condition.

7. The power supply of claim 4, wherein the sensing circuit is on the primary side and coupled to the switch by a second transformer.

8. A method of operating a power converter, comprising:
sensing if the power converter is coupled or not coupled to a load using a switch integrated into a power plug to deliver power to the load
when the power converter is not coupled to the load, placing the power converter into a low power quiescent operating mode
when the power converter is coupled to the load, operating the power converter normally to deliver power to the load.

9. A power supply comprising:
first means for converting AC primary power into DC power, the first means having a normal operating mode and a low power quiescent operating mode
a DC power plug for delivering DC power from the first means to a load
wherein the normal operating mode and the low power quiescent operating mode are selected by a switch integrated into the DC power plug.

10. The power supply of claim 9, wherein the switch has a first state indicating that the DC power plug is not engaged with a load and a second state indicating that the DC power plug is engaged with a load.

11. The power supply of claim 10, wherein the first means comprises
second means to sense the position of the switch
third means to cause the first means to operate in the low power quiescent mode, the third means coupled to the second means
wherein the third means causes the first means to operate in the low power quiescent operating mode when the second means senses that the switch is in the first state.

12. The power supply of claim 11, wherein the second means is optically coupled to the third means.

13. The power supply of claim 11, wherein the second means is coupled to the switch by a transformer.
